(19) United States
(12) Patent Application Publication
(10) Pub. No.: US 2013/0226435 A1
(43) Pub. Date: Aug. 29, 2013

(54) SYSTEMS AND METHODS FOR ADJUSTING AN ESTIMATED FLOW RATE OF EXHAUST GAS PASSING THROUGH AN EXHAUST GAS RECIRCULATION VALVE

(71) Applicants: Jon C. Wasberg, Davison, MI (US); Vijay Ramappan, Novi, MI (US); Layne K. Wiggins, Dexter, MI (US); Gregory J. York, Fenton, MI (US); Martino Casetti, Waterford, MI (US)

(72) Inventors: Jon C. Wasberg, Davison, MI (US); Vijay Ramappan, Novi, MI (US); Layne K. Wiggins, Dexter, MI (US); Gregory J. York, Fenton, MI (US); Martino Casetti, Waterford, MI (US)

(73) Assignee: GM Global Technology Operations LLC, Detroit, MI (US)

(21) Appl. No.: 13/408,577

(22) Filed: Feb. 29, 2012

(51) Int. Cl. F02D 41/26; F02M 25/07; F02D 28/00

(52) U.S. Cl. 701/102

(57) ABSTRACT

A system according to the principles of the present disclosure includes a volumetric efficiency adjustment module and an exhaust gas recirculation (EGR) flow adjustment module. The volumetric efficiency adjustment module adjusts an estimated volumetric efficiency of an engine based on a mass flow rate of air entering the engine. The EGR flow adjustment module selectively adjusts an estimated mass flow rate of exhaust gas passing through an EGR valve based on an amount by which the volumetric efficiency adjustment module adjusts the volumetric efficiency.

### FIELD

The present invention relates to systems and methods for adjusting an estimated flow rate of exhaust gas passing through an exhaust gas recirculation valve.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Internal combustion engines combust an air and fuel mixture within cylinders to drive pistons, which produces drive torque. Air flow into the engine is regulated via a throttle. More specifically, the throttle adjusts throttle area, which increases or decreases air flow into the engine. As the throttle area increases, the air flow into the engine increases. A fuel control system adjusts the rate that fuel is injected to provide a desired air/fuel mixture to the cylinders and/or to achieve a desired torque output. Increasing the amount of air and fuel provided to the cylinders increases the torque output of the engine.

In spark-ignition engines, spark initiates combustion of an air/fuel mixture provided to the cylinders. In compression-ignition engines, compression in the cylinders combusts the air/fuel mixture provided to the cylinders. Spark timing and air flow may be the primary mechanisms for adjusting the torque output of spark-ignition engines, while fuel flow may be the primary mechanism for adjusting the torque output of compression-ignition engines.

Engine control systems have been developed to control engine output torque to achieve a desired torque. Traditional engine control systems, however, do not control the engine output torque as accurately as desired. Further, traditional engine control systems do not provide a rapid response to control signals or coordinate engine torque control among various devices that affect the engine output torque.

### SUMMARY

A system according to the principles of the present disclosure includes a volumetric efficiency adjustment module and an exhaust gas recirculation (EGR) flow adjustment module. The volumetric efficiency adjustment module adjusts an estimated volumetric efficiency of an engine based on a mass flow rate of air entering the engine. The EGR flow adjustment module selectively adjusts an estimated mass flow rate of exhaust gas passing through an EGR valve based on an amount by which the volumetric efficiency adjustment module adjusts the volumetric efficiency.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example engine system according to the principles of the present disclosure;

FIG. 2 is a functional block diagram of an example engine control system according to the principles of the present disclosure; and

FIG. 3 is a flowchart illustrating an example engine control method according to the principles of the present disclosure.

### DETAILED DESCRIPTION

An engine control system may determine control parameters such as spark timing, fuel injection, throttle position, valve timing, and exhaust gas recirculation based on the torque output of an engine. The torque output of an engine may be estimated based on its volumetric efficiency. Volumetric efficiency may be a ratio (or percentage) of the quantity of air that enters a cylinder during induction to the actual (or geometric) capacity of the cylinder under static conditions. Volumetric efficiency may be estimated based on a pressure ratio across the engine, and the estimated volumetric efficiency may be adjusted based on a mass flow rate of air entering the engine under certain conditions. The amount by which the estimated volumetric efficiency is adjusted may be referred to as a volumetric efficiency (VE) correction factor.

The torque output of an engine may be affected by a mass flow rate of exhaust gas recirculated through an exhaust gas recirculation (EGR) valve. The mass flow rate of exhaust gas recirculated through the EGR valve may be estimated based on the pressure ratio across the engine and the position of the EGR valve. The estimated mass flow rate may be inaccurate due to, for example, a flow restriction in the EGR valve that increases in size over time and/or incorrect estimates of the pressure ratio across the engine. In turn, the amount of recirculated exhaust gas may be more or less than expected. Spark advance may be determined based on the estimated mass flow rate, as recirculated exhaust gas cools combustion within a cylinder and inhibits spark knock. Thus, inaccuracies in the estimated mass flow rate may lead to spark knock.

An engine control system and method according to the present disclosure adjusts an estimated mass flow rate of exhaust gas passing through an EGR valve based on the VE correction factor. The EGR valve may be closed and a first value of the VE correction factor may be determined when deceleration fuel cutoff is enabled. When deceleration fuel cutoff remains enabled while the EGR valve is closed, the EGR valve may be opened and a second value of the VE correction factor may be determined after the EGR valve is open for a predetermined period. The estimated mass flow rate may be adjusted when a difference between the first value and the second value is greater than a first threshold. The (adjusted) estimated mass flow rate may be used to perform closed loop control of the opening area of an EGR valve within the actuation limits of the EGR valve. In addition, a fault in the EGR valve may be detected when the difference between the first value and the second value is greater than a second threshold. The second threshold may be greater than the first threshold.

Detecting a fault in an EGR valve based on the VE correction factor may ensure that the EGR valve is built correctly when a vehicle is assembled and may identify flow restrictions in the EGR valve that grow in size over time. Adjusting the estimated mass flow rate of exhaust gas passing through the EGR valve based on the VE correction factor improves the accuracy of the estimated mass flow rate. In turn, spark timing may be advanced more aggressively without causing spark knock. Advancing spark timing generally improves fuel economy. Thus, improving the accuracy of the estimated mass flow rate of exhaust gas passing through the EGR valve may improve fuel economy and inhibit spark knock.

In addition, improving the accuracy of the estimated mass flow rate may improve the accuracy of the estimated torque output of an engine. This may be particularly beneficial in a hybrid system when coordinating the torque output of an engine with the torque output of an electric motor.

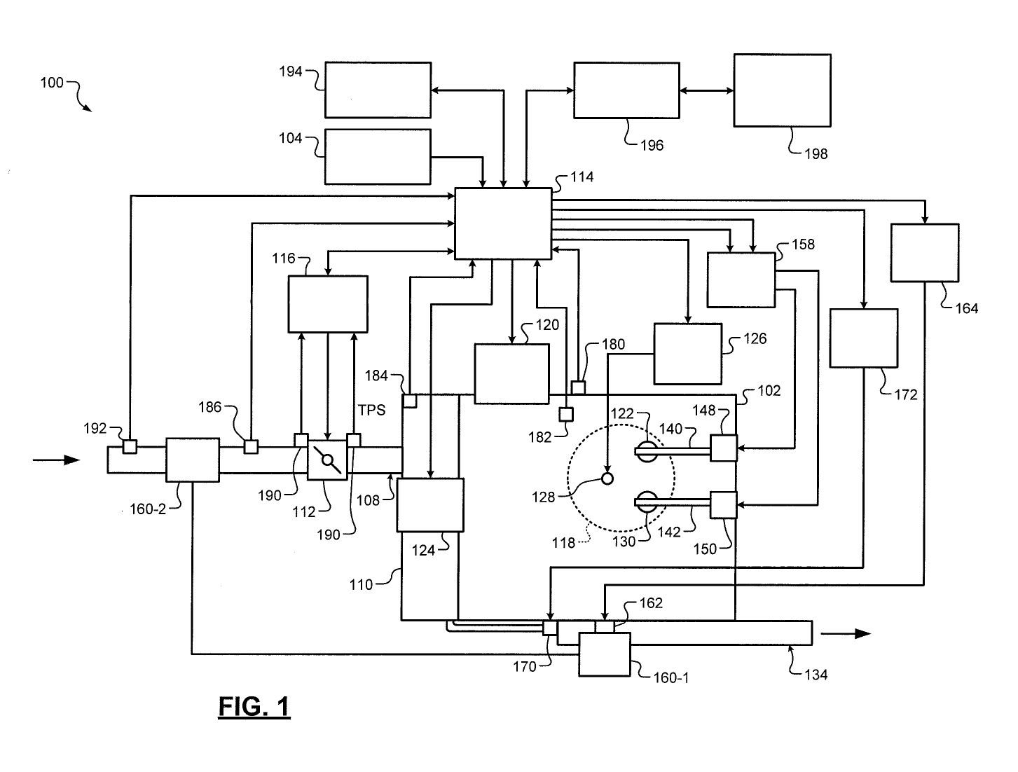

Referring now to FIG. 1, a functional block diagram of an exemplary engine system 100 is presented. The engine system 100 includes an engine 102 that combusts an air/fuel mixture to produce drive torque for a vehicle based on driver input from a driver input module 104. Air is drawn into the engine 102 through an intake system 108. For example only, the intake system 108 may include an intake manifold 110 and a throttle valve 112. For example only, the throttle valve 112 may include a butterfly valve having a rotatable blade. An engine control module (ECM) 114 controls a throttle actuator module 116, which regulates opening of the throttle valve 112 to control the amount of air drawn into the intake manifold 110.

Air from the intake manifold 110 is drawn into cylinders of the engine 102. While the engine 102 may include multiple cylinders, for illustration purposes a single representative cylinder 118 is shown. For example only, the engine 102 may include 2, 3, 4, 5, 6, 8, 10, and/or 12 cylinders. The ECM 114 may instruct a cylinder actuator module 120 to selectively deactivate some of the cylinders, which may improve fuel economy under certain engine operating conditions.

The engine 102 may operate using a four-stroke cycle. The four strokes, described below, are named the intake stroke, the compression stroke, the combustion stroke, and the exhaust stroke. During each revolution of a crankshaft (not shown), two of the four strokes occur within the cylinder 118. Therefore, two crankshaft revolutions are necessary for the cylinder 118 to experience all four of the strokes.

During the intake stroke, combustion gas from the intake manifold 110 is drawn into the cylinder 118 through an intake valve 122. The ECM 114 controls a fuel actuator module 124, which regulates fuel injection to achieve a desired air/fuel ratio. Fuel may be injected into the intake manifold 110 at a central location or at multiple locations, such as near the intake valve 122 of each of the cylinders. In various implementations (not shown), fuel may be injected directly into the cylinders or into mixing chambers associated with the cylinders. The fuel actuator module 124 may halt injection of fuel to cylinders that are deactivated.

The injected fuel mixes with combustion gas and creates an air/fuel mixture in the cylinder 118. During the compression stroke, a piston (not shown) within the cylinder 118 compresses the air/fuel mixture. The engine 102 may be a compression-ignition engine, in which case compression in the cylinder 118 ignites the air/fuel mixture. Alternatively, the engine 102 may be a spark-ignition engine, in which case a spark actuator module 126 energizes a spark plug 128 in the cylinder 118 based on a signal from the ECM 114, which ignites the air/fuel mixture. The timing of the spark may be specified relative to the time when the piston is at its topmost position, referred to as top dead center (TDC).

The spark actuator module 126 may be controlled by a timing signal specifying how far before or after TDC to generate the spark. Because piston position is directly related to crankshaft rotation, operation of the spark actuator module 126 may be synchronized with crankshaft angle. In various implementations, the spark actuator module 126 may halt provision of spark to deactivated cylinders.

Generating the spark may be referred to as a firing event. The spark actuator module 126 may have the ability to vary the timing of the spark for each firing event. The spark actuator module 126 may even be capable of varying the spark timing for a next firing event when the spark timing signal is changed between a last firing event and the next firing event. In various implementations, the engine 102 may include multiple cylinders and the spark actuator module 126 may vary the spark timing relative to TDC by the same amount for all cylinders in the engine 102.

During the combustion stroke, the combustion of the air/fuel mixture drives the piston down, thereby driving the crankshaft. The combustion stroke may be defined as the time between the piston reaching TDC and the time at which the piston returns to bottom dead center (BDC).

During the exhaust stroke, the piston begins moving up from BDC and expels the byproducts of combustion through an exhaust valve 130. The byproducts of combustion are exhausted from the vehicle via an exhaust system 134.

The intake valve 122 may be controlled by an intake camshaft 140, while the exhaust valve 130 may be controlled by an exhaust camshaft 142. In various implementations, multiple intake camshafts (including the intake camshaft 140) may control multiple intake valves (including the intake valve 122) for the cylinder 118 and/or may control the intake valves (including the intake valve 122) of multiple banks of cylinders (including the cylinder 118). Similarly, multiple exhaust camshafts (including the exhaust camshaft 142) may control multiple exhaust valves for the cylinder 118 and/or may control exhaust valves (including the exhaust valve 130) for multiple banks of cylinders (including the cylinder 118).

The cylinder actuator module 120 may deactivate the cylinder 118 by disabling opening of the intake valve 122 and/or the exhaust valve 130. In various other implementations, the intake valve 122 and/or the exhaust valve 130 may be controlled by devices other than camshafts, such as electromagnetic actuators.

The time at which the intake valve 122 is opened may be varied with respect to piston TDC by an intake cam phaser 148. The time at which the exhaust valve 130 is opened may be varied with respect to piston TDC by an exhaust cam phaser 150. A phaser actuator module 158 may control the intake cam phaser 148 and the exhaust cam phaser 150 based on signals from the ECM 114. When implemented, variable valve lift (not shown) may also be controlled by the phaser actuator module 158.

The engine system 100 may include a boost device that provides pressurized combustion gas to the intake manifold 110. For example, FIG. 1 shows a turbocharger including a hot turbine 160-1 that is powered by hot exhaust gases flowing through the exhaust system 134. The turbocharger also includes a cold air compressor 160-2, driven by the turbine 160-1, that compresses air leading into the throttle valve 112. In various implementations, a supercharger (not shown), driven by the crankshaft, may compress air from the throttle valve 112 and deliver the compressed combustion gas to the intake manifold 110.

A wastegate 162 may allow exhaust to bypass the turbine 160-1, thereby reducing the boost (the amount of intake air compression) of the turbocharger. The ECM 114 may control the turbocharger via a boost actuator module 164. The boost actuator module 164 may modulate the boost of the turbocharger by controlling the position of the wastegate 162. In various implementations, multiple turbochargers may be controlled by the boost actuator module 164. The turbocharger may have variable geometry, which may be controlled by the boost actuator module 164.

An intercooler (not shown) may dissipate some of the heat contained in the compressed combustion gas charge, which is generated as the combustion gas is compressed. The compressed combustion gas charge may also have absorbed heat from components of the exhaust system 134. Although shown separated for purposes of illustration, the turbine 160-1 and the compressor 160-2 may be attached to each other, placing intake air in close proximity to hot exhaust.

The engine system 100 may include an exhaust gas recirculation (EGR) valve 170, which selectively redirects exhaust gas back to the intake manifold 110. The EGR valve 170 may be located upstream of the turbocharger's turbine 160-1. In various implementations, the EGR valve 170 may be located downstream of the turbine 160-1, and exhaust gas recirculated through the EGR valve 170 may be introduced upstream from the compressor 160-2. The EGR valve 170 may be controlled by an EGR actuator module 172.

The engine system 100 may measure the speed of the crankshaft in revolutions per minute (RPM) using an RPM sensor 180. The temperature of the engine coolant may be measured using an engine coolant temperature (ECT) sensor 182. The ECT sensor 182 may be located within the engine 102 or at other locations where the coolant is circulated, such as a radiator (not shown).

The pressure within the intake manifold 110 may be measured using a manifold absolute pressure (MAP) sensor 184. In various implementations, engine vacuum, which is the difference between ambient air pressure and the pressure within the intake manifold 110, may be measured. The mass flow rate of air flowing into the intake manifold 110 may be measured using a mass air flow (MAF) sensor 186. In various implementations, the MAF sensor 186 may be located in a housing that also includes the throttle valve 112.

The throttle actuator module 116 may monitor the position of the throttle valve 112 using one or more throttle position sensors (TPS) 190. The ambient temperature of air being drawn into the engine 102 may be measured using an intake air temperature (IAT) sensor 192. The ECM 114 may use signals from the sensors to make control decisions for the engine system 100.

The ECM 114 may communicate with a transmission control module 194 to coordinate shifting gears in a transmission (not shown). For example, the ECM 114 may reduce engine torque during a gear shift. The ECM 114 may communicate with a hybrid control module 196 to coordinate operation of the engine 102 and an electric motor 198.

The electric motor 198 may also function as a generator, and may be used to produce electrical energy for use by vehicle electrical systems and/or for storage in a battery. In various implementations, various functions of the ECM 114, the transmission control module 194, and the hybrid control module 196 may be integrated into one or more modules.

Each system that varies an engine parameter may be referred to as an actuator that receives an actuator value. For example, the throttle actuator module 116 may be referred to as an actuator and the throttle opening area may be referred to as the actuator value. In the example of FIG. 1, the throttle actuator module 116 achieves the throttle opening area by adjusting an angle of the blade of the throttle valve 112.

Similarly, the spark actuator module 126 may be referred to as an actuator, while the corresponding actuator value may be the amount of spark advance relative to cylinder TDC. Other actuators may include the cylinder actuator module 120, the fuel actuator module 124, the phaser actuator module 158, the boost actuator module 164, and the EGR actuator module 172. For these actuators, the actuator values may correspond to number of activated cylinders, fueling rate, intake and exhaust cam phaser angles, boost pressure, and EGR valve opening area, respectively. The ECM 114 may control actuator values in order to cause the engine 102 to generate a desired engine output torque.

The ECM 114 may determine actuator values such as spark advance, fueling rate, and/or throttle area based on the torque output of the engine 102. The ECM 114 may estimate torque output of the engine 102 based on the volumetric efficiency of the engine 102. The ECM 114 may estimate the volumetric efficiency of the engine 102 based on a pressure ratio across the engine. The pressure ratio across the engine 102 is a ratio of a pressure upstream from the engine 102, such as the pressure within the intake manifold 110, to a pressure downstream from the engine 102. The ECM 114 may adjust the estimated volumetric efficiency based on the measured mass flow rate of air entering the engine 102. The amount by which the estimated volumetric efficiency is adjusted may be referred to as a volumetric efficiency (VE) correction factor.

The ECM 114 estimates a mass flow rate of exhaust gas passing through the EGR valve 170 based on the pressure ratio across the engine 102 and adjusts the estimated mass flow rate based on the VE correction factor. The ECM 114 may close the EGR valve 170 and determine a first value of the VE correction factor when deceleration fuel cutoff is enabled. The ECM 114 may enable deceleration fuel cutoff when the transmission is in gear, an accelerator pedal (not shown) is not depressed, and the speed of the engine 102 greater than idle speed. The ECM 114 may open the EGR valve 170 and determine a second value of the VE correction factor after the EGR valve 170 is opened for a predetermined period. The ECM 114 may adjust estimated mass flow rate when a difference between the first value and the second value is greater than a threshold.

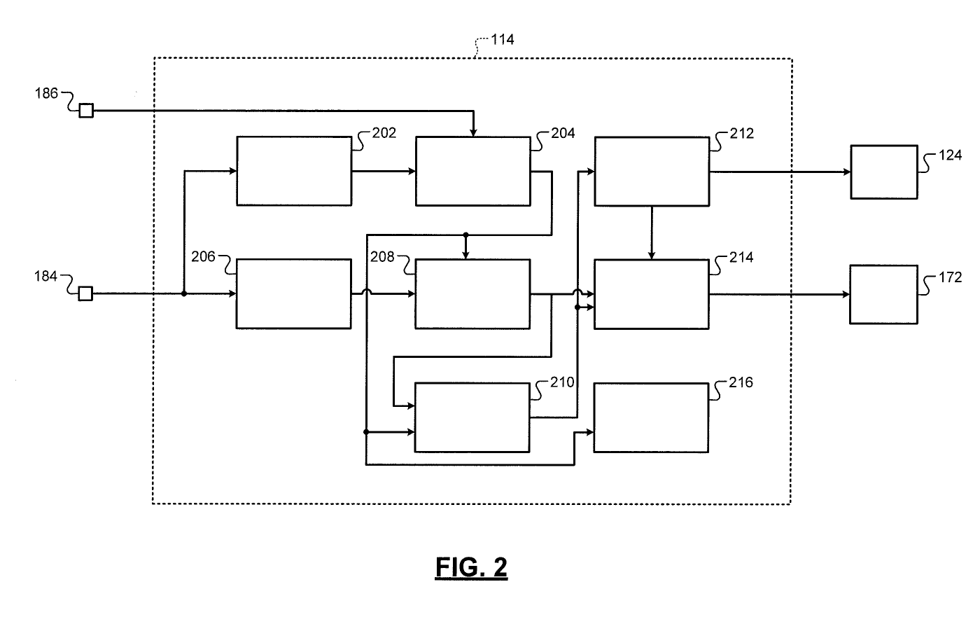

Referring now to FIG. 2, the ECM 114 may include a volumetric efficiency (VE) estimation module 202 and a volumetric efficiency (VE) adjustment module 204. The VE estimation module 202 estimates the volumetric efficiency of the engine 102. The VE estimation module 202 may estimate a mass flow rate of air passing through the engine 102 based on the volumetric efficiency. The VE estimation module 202 may estimate the volumetric efficiency based on a ratio of a first pressure upstream from the engine 102, such as the pressure within the intake manifold 110, to a second pressure downstream from the engine 102. The VE estimation module 202 may receive the first pressure from the MAP sensor 184. The VE estimation module 202 may estimate the second pressure based on the first pressure and/or other operating conditions. The VE estimation module 202 may output the estimated volumetric efficiency and the estimated mass flow rate of air passing through the engine 102.

The VE adjustment module 204 adjusts the estimated volumetric efficiency based on the mass flow rate measured by the MAF sensor 186. The VE adjustment module 204 may adjust the estimated volumetric efficiency by an amount that is proportional to a difference between the mass flow rate estimated by the VE estimation module 202 and the mass flow rate measured by the MAF sensor 186. The amount by which the volumetric efficiency is adjusted may be referred to as a volumetric efficiency (VE) correction factor. The VE adjustment module 204 outputs the (adjusted) estimated volumetric efficiency and the VE correction factor.

An EGR flow estimation module 206 estimates a mass flow rate of exhaust gas recirculated through the EGR valve 170. The EGR flow estimation module 206 may estimate the mass flow rate of exhaust gas based on the EGR valve opening area, a first pressure upstream from the EGR valve 170, and a second pressure downstream from the EGR valve 170. The EGR flow estimation module 206 may receive the second pressure from the MAP sensor 184. The EGR flow estimation module 206 may estimate the first pressure based on the second pressure and/or other operating conditions.

The EGR flow estimation module 206 may estimate the mass flow rate of exhaust gas recirculated through the EGR valve 170 using the following relationship:

$$\dot{m} = \frac{{C}_{D} {A}_{r} {P}_{0}}{\sqrt{{RT}_{0}}} {( \frac{{P}_{r}}{{P}_{0}} )}^{1 / γ} {\{ \frac{2 γ}{γ - 1} [ 1 - {( \frac{{P}_{r}}{{P}_{0}} )}^{( γ - 1 ) / γ} ] \}}^{1 / 2} \qquad ( 1 )$$

where mass flow rate (\dot{m}) is a function of EGR valve opening area (Aᵣ), the first pressure (P₀) upstream from the EGR valve 170, a temperature (T₀), the second pressure (Pᵣ) downstream from the EGR valve 170, and various constants (C_{D}, R, γ). This relationship may be modeled by an equation and/or may be stored as a lookup table. For example, a lookup table relating the constant (C_{D}) to various operating conditions may be developed through engine calibration. The EGR flow estimation module 206 outputs the estimated mass flow rate of recirculated exhaust gas.

An EGR flow adjustment module 208 adjusts the estimated mass flow rate of exhaust gas recirculated through the EGR valve 170 based on the VE correction factor. The EGR flow adjustment module 208 may adjust the estimated mass flow rate of exhaust gas based on a change in the VE correction factor as the EGR valve 170 is switched from closed to open. The VE correction factor may have a first value when the EGR valve 170 is closed and a second value when the EGR valve 170 is open. The EGR flow adjustment module 208 may adjust the estimated mass flow rate when a difference between the first value and the second value is greater than a first threshold. The EGR flow adjustment module 208 outputs the (adjusted) estimated mass flow rate of exhaust gas recirculated through the EGR valve 170.

A torque estimation module 210 estimates the torque output of the engine 102. The torque estimation module 210 may estimate the torque output of the engine 102 based on engine actuator values. For example, the torque output of the engine 102 may be estimated based on the following relationship:

T=f(MAF, S, I, E, AF, #, EGR) (2)

where torque (T) is a function of mass flow rate (MAF), spark advance (S), intake cam phaser position (I), exhaust cam phaser position (E), air/fuel ratio (AF), number of activated cylinders (#), and estimated mass flow rate of exhaust gas through the EGR valve 170 (EGR). This relationship may be modeled by an equation and/or may be stored as a lookup table. The torque estimation module 210 outputs the estimated torque. The estimated torque may be used to perform closed-loop control of actuator values such as throttle area, fueling rate, spark advance, phaser positions, and EGR valve opening area. Closed-loop control of the EGR valve opening area may be based on a desired mass flow rate of recirculated exhaust gas and/or a desired mass fraction of recirculated exhaust gas.

A fuel control module 212 controls fuel flow to cylinder(s) of the engine 102. The fuel control module 212 may cut off fuel supply to cylinder(s) of the engine 102 when deceleration fuel cutoff is enabled. The fuel control module 212 may enable deceleration fuel cutoff when the transmission is in gear, the accelerator pedal is not depressed, and the speed of the engine 102 is greater than idle speed.

During normal operation of a spark-ignition engine, the fuel control module 212 may operate in an air lead mode in which the fuel control module 212 attempts to maintain a stoichiometric air/fuel ratio by controlling fuel flow based on air flow. The fuel control module 212 may determine a fuel mass that will yield stoichiometric combustion when combined with the current amount of air per cylinder. The fuel control module 212 may instruct the fuel actuator module 124 via the fueling rate to inject this fuel mass for each activated cylinder.

In compression-ignition systems, the fuel control module 212 may operate in a fuel lead mode in which the fuel control module 212 determines a fuel mass for each cylinder that satisfies a torque request while minimizing emissions, noise, and fuel consumption. In the fuel lead mode, air flow is controlled based on fuel flow and may be controlled to yield a lean air/fuel ratio. In addition, the air/fuel ratio may be maintained above a predetermined level, which may prevent black smoke production in dynamic engine operating conditions.

A valve control module 214 controls the opening area of the EGR valve 170. The valve control module 214 may instruct the EGR actuator module 172 to adjust the EGR valve 170 to a desired opening area. The valve control module 214 may adjust the desired opening area within the actuation limits of the EGR valve 170 based on the estimated mass flow rate of recirculated exhaust gas. The valve control module 214 may close the EGR valve 170 when deceleration fuel cutoff is enabled. The valve control module 214 may determine when deceleration fuel cutoff is enabled based on input received from the fuel control module 212. The valve control module 214 may open the EGR valve 170 to a predetermined position after the EGR valve 170 is closed for a predetermined period while deceleration fuel cutoff remains enabled.

A fault detection module 216 detects a fault in an EGR system based on the VE correction factor. The EGR system includes the EGR valve 170 and may include other hardware components such as an EGR gas cooler. The fault detection module 216 may detect a fault in the EGR system when the difference between the first value of the VE correction factor and the second value of the VE correction factor is greater than a second threshold. The second threshold may be greater than the first threshold.

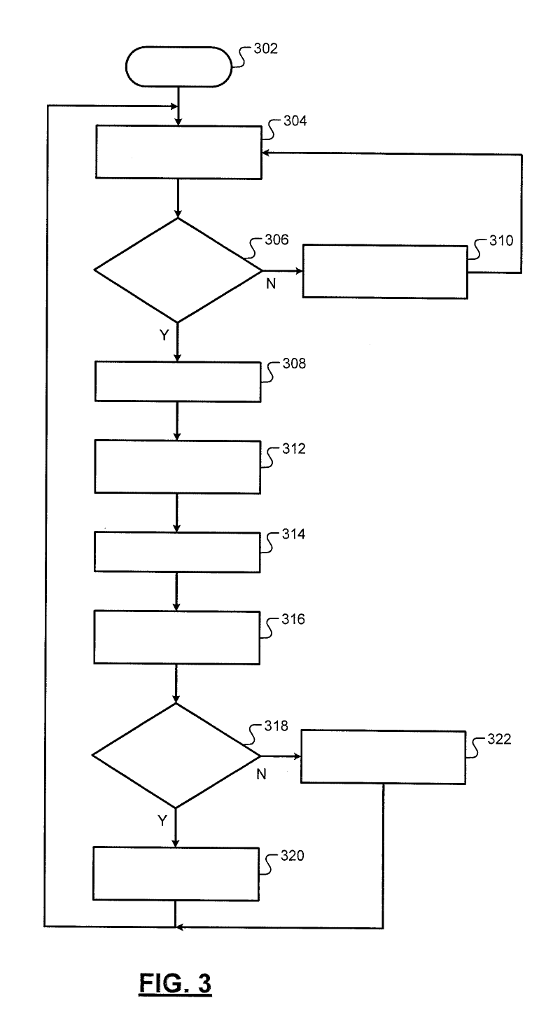

Referring now to FIG. 3, a method for adjusting an estimated mass flow rate of exhaust gas passing through an exhaust gas recirculation (EGR) valve begins at 302. At 304, the method estimates a mass flow rate of exhaust gas passing through an EGR valve. The method may estimate the mass flow rate based on a ratio of a first pressure upstream from the EGR valve to a second pressure downstream from the EGR valve. The first pressure may be estimated and the second pressure may be measured. The method may estimate the mass flow rate using relationship (1) discussed above.

At 306, the method determines whether deceleration fuel cutoff is enabled. Deceleration fuel cutoff may be enabled when a transmission is in gear, an acceleration pedal is not depressed, and the speed of an engine is greater than idle speed. The method may also determine whether other enabling conditions are satisfied. For example, the method may ensure that the change rate(s) of manifold pressure and/or engine speed is/are less than a predetermined rate. If deceleration fuel cutoff is enabled, the method continues at 308. Otherwise, the method continues at 310.

At 310, the method controls the EGR valve based on a predetermined schedule. For example, the method may adjust the EGR valve to a desired opening area that is extracted from a lookup table. The lookup table may relate the desired opening area to engine operating conditions such as pressure within an intake manifold.

At 308, the method closes the EGR valve. At 312, the method determines a first value of a volumetric efficiency (VE) correction factor. The method may determine the first value based on an average of the VE correction factor over a first period when the EGR valve is closed.

At 314, the method opens the EGR valve. The method may open the EGR valve to a predetermined position after the EGR valve is closed for a predetermined period. At 316, the method determines a second value of the VE correction factor. The method may determine the second value based on an average of the VE correction factor over a second period when the EGR valve is open.

At 318, the method determines whether a difference between the first value and the second value is greater than a first threshold. When the difference between the first value and the second value is greater than the first threshold, the method continues at 320. Otherwise, the method continues at 322. At 322, the method does not adjust the estimated mass flow rate of exhaust gas passing through the EGR valve.

At 320, the method adjusts the estimated mass flow rate of exhaust gas passing through the EGR valve based on the VE correction factor. The method may adjust the estimated mass flow rate by an amount that is based on the difference between the first and second values of the VE correction factor and/or based on a ratio of the first and second values of the VE correction factor.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

What is claimed is:

1. A system comprising:
a volumetric efficiency adjustment module that adjusts an estimated volumetric efficiency of an engine based on a mass flow rate of air entering the engine; and
an exhaust gas recirculation (EGR) flow adjustment module that selectively adjusts an estimated mass flow rate of exhaust gas passing through an EGR valve based on an amount by which the volumetric efficiency adjustment module adjusts the volumetric efficiency.

2. The system of claim 1, wherein the mass flow rate of air is measured.

3. The system of claim 1, further comprising a valve control module that controls the EGR valve.

4. The system of claim 3, wherein the valve control module controls the EGR valve based on the estimated mass flow rate.

5. The system of claim 3, wherein the valve control module closes the EGR valve when the engine is decelerating and fuel to the engine is cut off.

6. The system of claim 3, wherein the valve control module opens the EGR valve after the EGR valve is closed for a predetermined period.

7. The system of claim 1, wherein the volumetric efficiency adjustment module adjusts the estimated volumetric efficiency by a first amount when the EGR valve is closed and adjusts the estimated volumetric efficiency by a second amount when the EGR valve is open.

8. The system of claim 7, wherein the EGR flow adjustment module adjusts the estimated mass flow rate when a difference between the first amount and the second amount is greater than a threshold.

9. The system of claim 7, wherein the EGR flow adjustment module adjusts the estimated mass flow rate by a third amount that is based on at least one of: (i) a difference between the first amount and the second amount; and (ii) a ratio of the first amount and the second amount.

10. The system of claim 7, further comprising a fault detection module that detects a fault in the EGR valve when a difference between the first amount and the second amount is greater than a threshold.

11. A method comprising:
adjusting an estimated volumetric efficiency of an engine based on a mass flow rate of air entering the engine; and
selectively adjusting an estimated mass flow rate of exhaust gas passing through an exhaust gas recirculation (EGR) valve based on an amount by which the volumetric efficiency is adjusted.

12. The method of claim 11, wherein the mass flow rate of air is measured.

13. The method of claim 11, further comprising controlling the EGR valve.

14. The method of claim 13, further comprising controlling the EGR valve based on the estimated mass flow rate.

15. The method of claim 13, further comprising closing the EGR valve when the engine is decelerating and fuel to the engine is cut off.

16. The method of claim 13, further comprising opening the EGR valve after the EGR valve is closed for a predetermined period.

17. The method of claim 11, further comprising adjusting the estimated volumetric efficiency by a first amount when the EGR valve is closed and adjusting the estimated volumetric efficiency by a second amount when the EGR valve is open.

18. The method of claim 17, further comprising adjusting the estimated mass flow rate when a difference between the first amount and the second amount is greater than a threshold.

19. The method of claim 17, further comprising adjusting the estimated mass flow rate by a third amount that is based on at least one of: (i) a difference between the first amount and the second amount; and (ii) a ratio of the first amount and the second amount.

20. The method of claim 17, further comprising detecting a fault in the EGR valve when a difference between the first amount and the second amount is greater than a threshold.
